(19) United States
(12) Patent Application Publication
(10) Pub. No.: US 2005/0025590 A1
(43) Pub. Date: Feb. 3, 2005

(54) Adapter device for operating a tap

(76) Inventor: Giorgio Spadaccini, Omegna (IT)

Correspondence Address: NIXON & VANDERHYE, PC, 1100 N GLEBE ROAD, 8TH FLOOR, ARLINGTON, VA, 22201-4714, US

(21) Appl. No.: 10/499,536

(22) PCT Filed: Dec. 12, 2002
(86) PCT No.: PCT/IB02/05300

(30) Foreign Application Priority Data
Dec. 19, 2001 (IT) MI2001 A 002686

(51) Int. Cl. B23G 5/00

(52) U.S. Cl. 408/199

(57) ABSTRACT

An adapter device for operating a tap, having at least one support element that can be mounted in an axially variable position with respect to the tap body and at least one operating stem fitted in an axially fixed position on the support element with possibility of rotation with respect to the same.

### TECHNICAL FIELD OF THE INVENTION

The present invention concerns an adapter device for operating a tap.

A device according to the invention may be applied, for example, on taps for intercepting water in the ordinary hydraulic systems installed in buildings, but it is understood that the invention is not limited in its applications to only water taps, nor even to the environments in which they may be installed.

### BACKGROUND ART

In the most common hydraulic systems, the body of a tap is generally fitted into a supporting wall before other finishing operations on the wall are carried out, for example by applying plaster, tiles, or all the works that can involve the installing of a wall at a distance from the supporting wall, such as walls or panels of plasterboard and the like.

At the time of installation it is good practice to bear in mind that, once the work is finished, the threaded portion of the tap body in which the shutoff member is housed must project by a sufficient distance to allow the mounting of a retaining and/or finishing ring-nut, as well as the mounting of a suitable operating handle or lever on the rod that controls the shutoff member.

It is therefore clear that any error in the positioning of the tap body can prevent the correct mounting of the retaining and/or finishing ring-nut, as well as the operating handle or lever of the shutoff member. In this case, for example, there are known some headworks (i.e. cartridges having the shutoff member therein and an operating rod projecting from the same) provided with an operating rod that is particularly long and divided into sectors.

The rod may be cut as required to allow the correct assembly of at least the handle or the operating lever, but it is clear that this is only a partial solution to the problem. In fact, if the threaded portion of the tap body does not project sufficiently from the finished surface, it is not possible to mount any fixing and/or finishing ring-nut, thus compromising the appearance and the quality of the installation work, if not even the operation of the tap.

To remedy this, long and heavy operations on the already finished work may therefore be necessary, above all in the case where walls or panels have been installed at a distance from the supporting wall in which the tap body is fitted.

### SUMMARY OF THE INVENTION

The task of the present invention is to provide a device which enables the solving of the above-mentioned drawbacks involved with the installation of taps or of sets of taps.

In view of this task, one object of the present invention is to provide an adapter device which allows compensation of the tolerances of installation between the body of a tap, or of a set of taps, and the external surface, so as to be able to correctly apply and operate the corresponding handles or levers.

Another object of the present invention is to provide an adapter device which is particularly economic and simple and quick to install. A further object of the present invention is to provide an adapter device which can be easily applied even on taps that are already installed, without requiring radical alterations.

These objects are achieved by the present invention, which concerns an adapter device for operating a tap, of the type including means for connecting at least one handle or lever to the rod that controls the shutoff member of the tap, characterised in that the connecting means include at least one support element that can be mounted in an axially variable position with respect to the tap body and at least one operating stem fitted in an axially fixed position on the support element with possibility of rotation with respect to the same.

In particular, the support element has a substantially cylindrical shape and includes, at the end opposite the one on which the operating stem is fitted, an internally threaded portion suitable for screwing engagement onto an externally threaded portion of the tap body.

The operating stem preferably includes at least one end portion, projecting on the outside of the support element, which has a shape and dimensions such as to allow the mounting of a handle or lever and the driving of the operating stem in rotation by the same handle or lever. At the opposite end, the operating stem includes at least one hollow end portion to receive inside it the control rod of the tap shutoff member, with driving engagement in rotation, and with possibility of axial sliding with respect to the same.

According to a possible embodiment, the support element also includes one or more threaded portions on its external surface in order to allow the screwing on of at least one fixing and/or finishing ring-nut. Alternatively, the ring may be made in a single piece with the support element, or integrally coupled to it.

It is clear that the support element can be screwed onto the threaded portion of the tap body until it allows the projection of an external threaded portion sufficient to allow a ring-nut to be screwed on up to abutment with the external surface of the site of installation. Alternatively, the ring may be permanently fitted or pre-screwed onto the support element, in order to allow the latter to be screwed onto the threaded portion of the tap body until it reaches the desired axial portion, still with the ring in abutment with the external surface.

Thanks to the cavity with shape and dimensions suitable for receiving the axially sliding rod for controlling the tap shutoff member, the control rod allows the transmission of the operating movement from the projecting portion, where the operating handle or lever is actually mounted on the same control rod of the shutoff member.

This solution can also be applied advantageously in those cases in which, for aesthetic reasons, the operating handle or lever must be placed in a position axially distant from the tap body and/or from the shutoff member associated with it, for example in cases where the tap body is not walled up but is placed below the level of a sink or the like, allowing only the operating handles or levers to project from the top of the sink.

### BRIEF DESCRIPTION OF THE DRAWINGS

Further characteristics and advantages of the present invention will be clearer from the following description which refers to the enclosed schematic drawings, in which:

FIG. 1 is a fragmentary view illustrating a device according to a possible embodiment of the present invention applied on a tap;

FIG. 2 is a section view of the support element of the device in FIG. 1; and

FIG. 3 is a section view of the operating stem of the device in FIG. 1.

### MODES FOR CARRYING OUT THE INVENTION

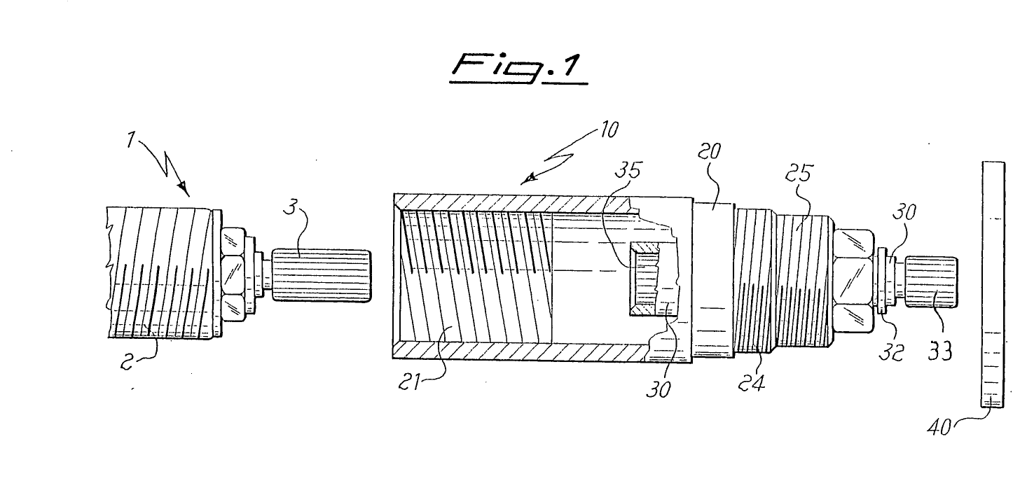

FIG. 1 illustrates a device 10 according to the present invention and a portion of a tap 1 on which the device 10 may be applied.

The tap 1 includes in particular a threaded portion 2 of the tap body in which is fitted for example a headwork provided with a control rod 3 made in the form of a grooved shaft. All these elements are of a standardised type and are therefore easily available on the market.

A device 10 made according to the present invention essentially includes a support element 20 and a operating stem 30. The support element 20 has a substantially cylindrical shape and includes an internally threaded portion 21 which is screwed onto the externally threaded portion 2 of the tap body. The support element 20 can thus be turned with respect to the tap body 1 to vary the mutual axial position between the tap and the support element.

On the external surface of the support element 20 there are one or more threaded portions, for example those indicated with the reference numbers 24 and 25, on at least one of which may be screwed a fixing and/or finishing ring-nut 40.

Alternatively, the ring 40 may be made in a single piece with the support element 20, or permanently coupled to it by gluing, welding, coupling with interference fit or the like.

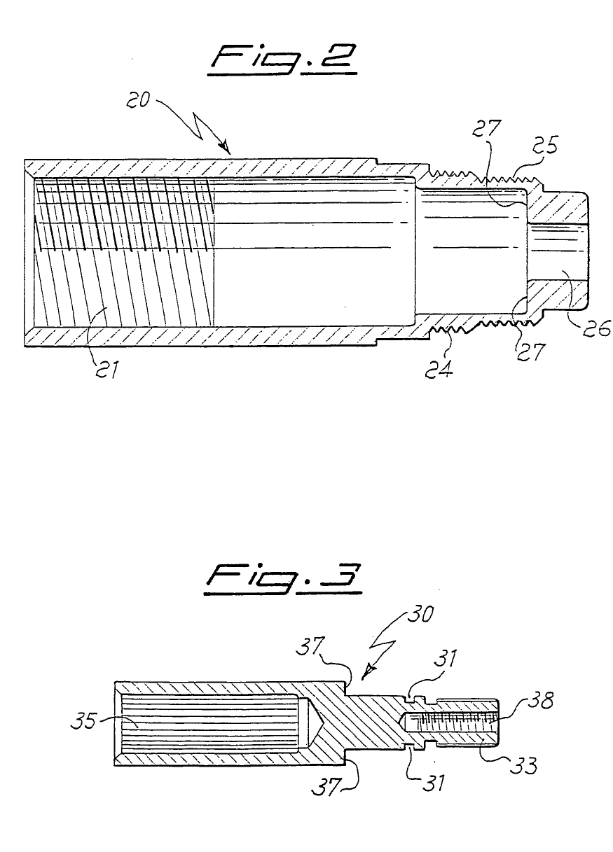

Referring also to FIGS. 2 and 3, it may be seen that, projecting from the support element 20, at the end opposite the one where there is the threaded portion 21, there is a portion 33 of the operating stem 30 having a shape and dimensions such as to allow the mounting of an operating handle or lever of the tap. In the embodiment here represented, the portion 33 has the same shape and the same dimensions as the rod for controlling the shutoff member of a standard headwork, with a threaded hole 38 intended to receive a fixing screw of the handle or lever.

It can also be seen that the operating stem 30 is inserted in a cylindrical through hole 26 of the support element 20 with a projecting portion 37 of the stem 30 which rests against the wall 27 around the hole 26. Between the projecting portion 37 and the wall 27, rings or washers may be inserted, for example to compensate the play and/or to reduce sliding friction between the contacting surfaces.

The stem 30 is held in position by a snap ring 32 (FIG. 1) housed in a special groove 31 of the stem 30, in such a way that it is axially fixed with respect to the support element 20, but is able to turn with respect to the same.

The stem 30, on the side opposite the portion 33, includes a hollow portion 35 which receives inside it the control rod 3 of the tap shutoff member. The shape and the dimensions of the hollow portion 35 are such as to allow the axial sliding of the control rod 3 inside the hollow portion 35, as well as the driving in rotation of the control rod 3 by the stem 30, and therefore of the handle or lever mounted on the portion 33.

Various modifications may be contemplated without departing from the scope of the present invention. For example, the shape and the dimensions of the control rod 3 and of the corresponding cavity 35 can also be different from those represented as long as driving in rotation is allowed and the possibility of axial sliding of the same.

As another alternative to the embodiment represented in FIGS. 1-3, the external surface of the support element 20 may include further threaded portions or, at the most, it may be entirely threaded to satisfy the requirements of particular applications.

As a further embodiment alternative to the represented one, the support element 20 may be without the internal thread 21 and have an internal diameter slightly larger than the external diameter of the portion 2 of the tap body, so as to be able to slide axially with respect to the same. In this case, a fixing plate may be advantageously provided, to be fitted integral with the support element 20 to allow it to be fixed to a surface with known means, such as screws or the like.

1. Adapter device for operating a tap, including means for connecting at least one handle or lever to the rod that controls the shutoff member of said tap, wherein said connecting means include at least one support element that can be mounted in an axially variable position with respect to said tap body and at least one operating stem fitted in an axially fixed position on said support element with possibility of rotation with respect to the same.

2. A device according to claim 1, wherein said support element has a substantially cylindrical shape and includes, at the end opposite the one on which said operating stem is fitted, an internally threaded portion suitable for screwing engagement onto an externally threaded portion of said tap body.

3. A device according to claim 1, wherein said operating stem includes at least one end portion projecting on the outside of said support element and having shape and dimensions such as to allow the mounting of a handle or lever and the driving of said operating stem in rotation by said handle or lever.

4. A device according to claim 1, wherein said operating stem includes at least one hollow end portion, opposite said end portion projecting from said support element, suitable to receive inside it the control rod of the shutoff member of said tap with driving engagement in rotation and with possibility of axial sliding with respect to the same.

5. A device according to claim 1, further including at least one fixing and/or finishing ring on said support element.

6. A device according to claim 5, wherein said fixing and/or finishing ring is made in a single piece with said support element.

7. A device according to claim 5, wherein said fixing and/or finishing ring is permanently coupled to said support element by gluing, welding or forced coupling.

8. A device according to claim 1, wherein said support element includes one or more threaded portions on its external surface and said ring includes a threaded hole to allow the engagement by screwing onto said support element.

9. A device according to claim 1, wherein said support element has a substantially cylindrical shape with a diameter slightly larger than the external diameter of the body of said tap at the point corresponding to the shutoff member of the same, so as to be able to slide axially with respect to the body of said tap.

10. A device according to claim 9, further including at least one fixing plate mounted on said support element.

11. Tap for intercepting fluids, characterised by including an adapter device according to claim 1.

12. Water supply set having one or more taps for intercepting fluids, characterised by including at least one adapter device according to claim 1.
